(19) United States
(12) Patent Application Publication
(10) Pub. No.: US 2025/0296776 A1
(43) Pub. Date: Sep. 25, 2025

(54) MOBILE BODY, TRANSPORT SYSTEM, CONTROL DEVICE, METHOD FOR TRANSPORTING TRANSPORTED OBJECT, AND NON-TRANSITORY COMPUTER READABLE STORAGE MEDIUM

(71) Applicant: Kabushiki Kaisha Toshiba, Tokyo (JP)

(72) Inventor: Yusuke ITO, Yokohama (JP)

(73) Assignee: Kabushiki Kaisha Toshiba, Tokyo (JP)

(21) Appl. No.: 19/046,596

(22) Filed: Feb. 6, 2025

(30) Foreign Application Priority Data
Mar. 22, 2024 (JP) 2024-045995

(51) Int. Cl. B65G 1/137; B65G 1/04

(52) U.S. Cl. CPC B65G 1/137; B65G 1/0492

(57) ABSTRACT

A mobile body to transport objects disposed in a plurality of designated regions, includes: a moving mechanism configured to move the mobile body along a transport route of the transported objects; a detection unit configured to detect surroundings information; and a determination unit configured to acquire detection results of the detection unit. The determination unit determines presence or absence of the transported objects in the designated regions by using the detection results of the detection unit when the mobile body is moving near the designated regions on the transport route.

### CROSS-REFERENCE TO RELATED APPLICATION

Priority is claimed on Japanese Patent Application No. 2024-045995, filed Mar. 22, 2024, the content of which is incorporated herein by reference.

### FIELD

The present disclosure relates to a mobile body, a transport system, a control device, a method for transporting a transported object, and a non-transitory computer readable storage medium.

### BACKGROUND

It is required to introduce robots to automate tasks performed by humans. As a robot for automating tasks performed by humans, a mobile robot that moves autonomously has been proposed. For example, a mobile robot introduced at a site transports transported objects placed in designated regions.

### BRIEF DESCRIPTION OF THE DRAWINGS

FIG. 1 is a functional block diagram of a transport system according to the present embodiment.

FIG. 2 is a diagram showing a detecting operation of a transported object performed by a mobile body provided in the transport system.

FIG. 3 is a diagram showing an example of transported object information included in the transport system.

FIG. 4 is a flowchart showing a method for transporting a transported object performed by the transport system.

### DETAILED DESCRIPTION

A mobile body of an embodiment transports objects disposed in a plurality of designated regions. The mobile body includes: a moving mechanism configured to move the mobile body along a transport route of the transported objects; a detection unit configured to detect surroundings information; and a determination unit configured to acquire detection results of the detection unit. The determination unit determines presence or absence of the transported objects in the designated regions by using the detection results of the detection unit when the mobile body is moving near the designated regions on the transport route.

A mobile body, a transport system, a control device, a method for transporting a transported object, and a program according to embodiments will be described below with reference to the drawings.

In the following description, the same reference signs will be given to configurations having the same or similar functions. In addition, repeated description of those configurations may be omitted. Further, “based on XX” in the present application indicates “based on at least XX” and includes a case based on another element in addition to XX. Also, “based on XX” is not limited to a case in which XX is directly used, and also includes a case based on the results acquired by performing calculation or processing on XX. “XX” is arbitrary element (for example, arbitrary information).

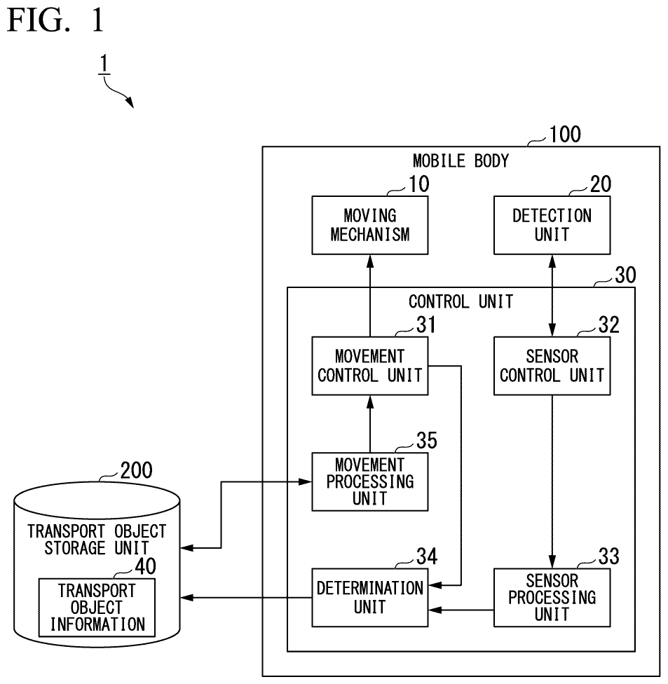

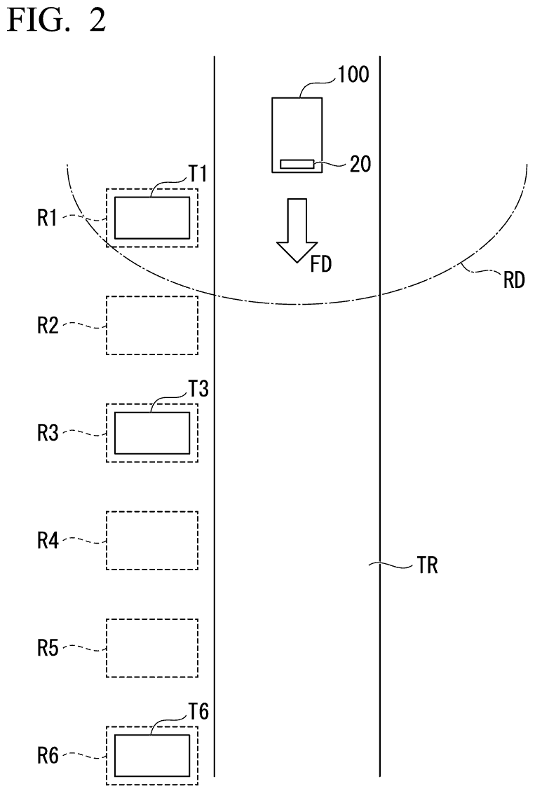

One embodiment will be described with reference to FIGS. 1 to 4. FIG. 1 is a functional block diagram of a transport system 1 according to the present embodiment. FIG. 2 is a diagram showing an operation of detecting transported objects performed by a mobile body 100 according to the present embodiment.

The transport system 1 includes a mobile body 100 and a transported object storage unit 200.

The mobile body 100 includes a moving mechanism 10, a detection unit 20, and a control unit 30. As shown in FIG. 2, the mobile body 100 is an autonomous mobile robot that can move along a transport route TR in a traveling direction FD. The mobile body 100 is, for example, an unmanned transport vehicle such as an automatic guided vehicle (AGV) or an autonomous mobile robot (AMR) used in a logistics warehouse.

The moving mechanism 10 is a drive mechanism that can move the mobile body 100 along the transport route TR. In the present embodiment, the moving mechanism 10 is a four-wheel drive mechanism having four wheels that come into contact with a floor surface of the transport route TR and are rotated by an electric motor or the like to move the mobile body 100 in the traveling direction FD. The moving mechanism 10 may have three or less wheels or five or more wheels, or may be a drive mechanism such as a caterpillar.

The mobile body 100 may be a multi-legged robot or an air vehicle such as a drone as long as it can move along the transport route TR. The moving mechanism 10 may be a multi-legged mechanism that can move the mobile body 100, or may be a propeller that is rotated by an electric motor or the like to generate a propulsive force.

Designated regions, in which transported objects to be transported by the mobile body 100 are placed, are disposed around the transport route TR along which the mobile body 100 moves. The mobile body 100 is a transport robot that transports the transported objects placed in the designated regions.

As shown in FIG. 2, in the present embodiment, six designated regions arranged along the transport route TR are provided around the transport route TR.

The six designated regions will be referred to as a first designated region R1, a second designated region R2, a third designated region R3, a fourth designated region R4, a fifth designated region R5, and a sixth designated region R6 in order of proximity to the mobile body 100 moving in the traveling direction FD.

The number of designated regions provided around the transport route TR may be five or less, or seven or more. Also, the designated regions may be provided on both sides of the transport route TR.

In the example shown in FIG. 2, the transported objects are disposed in the first designated region R1, the third designated region R3, and the sixth designated region R6. The transported object disposed in the first designated region R1 will be referred to as a first transported object T1. The transported object disposed in the third designated region R3 will be referred to as a third transported object T3. The transported object disposed in the sixth designated region R6 will be referred to as a sixth transported object T6.

When the mobile body 100 transports the first transported object T1, for example, it moves along the transport route TR and moves to the vicinity of the first designated region R1. The mobile body 100 that has arrived at the vicinity of the first designated region R1 holds the first transported object T1.

The mobile body 100 moves along the transport route TR while holding the first transported object T1, and transports the first transported object T1.

The transported object transported by the mobile body 100 is, for example, a pallet on which mail, luggage, and the like to be shipped from a logistics warehouse in which the transport system 1 is installed are stored or packed.

The transported object is, for example, a wheeled pallet having a plurality of wheels. The mobile body 100 or the transported object is provided with a coupling mechanism for coupling the mobile body 100 with the transported object.

The transported object coupled to the mobile body 100 by the coupling mechanism is pulled by the mobile body 100, moves together with the mobile body 100 while rotating its wheels, and is transported by the mobile body 100.

The mobile body 100 may include, for example, a table on which the transported object is placed, and a robot device that holds the transported object and places it on the table. In this case, the mobile body 100 moves the transported object from the designated region to the table using the robot device and moves with the transported object placed on the table, thereby transporting the transported object.

The detection unit 20 is a sensor that can detect surroundings information. In the present embodiment, the detection unit 20 is a one-dimensional horizontal scanning laser range finder (LRF). The detection unit 20 is provided on the traveling direction FD side (front) of the mobile body 100.

The detection unit 20 may be a two-dimensional scanning LRF, or other optical sensors, ultrasonic sensors, or the like. Also, arrangement of the detection unit 20 is not limited to the front of the mobile body 100, and may be disposed at the rear or on the left or right side. Further, a vertical height at which the detection unit 20 is disposed is not limited.

The control unit 30 is a control device that can control a part or the whole of the transport system 1. In the present embodiment, the control unit 30 is provided in the mobile body 100 and controls operations of the mobile body 100.

The control unit 30 is, for example, a program-executable device (computer) including a processor, a memory, a storage unit, and the like. Each function of the control unit 30 is realized by one or more processors, such as a central processing unit (CPU) or a graphics processing unit (GPU), executing a program stored in a program memory. However, all or some of these functions may be realized by hardware (for example, a circuit unit; circuitry) such as a large scale integration (LSI), an application specific integrated circuit (ASIC), a field-programmable gate array (FPGA), or a programmable logic device (PLD). Also, all or some of the above functions may be realized by a combination of software and hardware. The storage unit is realized by a flash memory, an electrically erasable programmable read-only memory (EEPROM), a read-only memory (ROM), a random access memory (RAM), or the like.

The control unit 30 includes a movement control unit 31, a sensor control unit 32, a sensor processing unit 33, a determination unit 34, and a movement processing unit 35.

The movement control unit 31 uses travel route and obstacle information to control movements of the mobile body 100. The movement control unit 31 controls the moving mechanism 10 and a moving operation of the mobile body 100.

The movement control unit 31 calculates a movement control value using a method such as the dynamic window approach or elastic band method. The movement control unit 31 may calculate the movement control value using other methods.

The movement control unit 31 may update a current self-position of the mobile body 100. Also, the movement control unit 31 may perform other controls.

The sensor control unit 32 controls the detection unit 20 and instructs the detection unit 20 to start or end surrounding environment measurements. In addition, the sensor control unit 32 acquires the detection results of the detection unit 20 from the detection unit 20.

The sensor processing unit 33 acquires the detection results of the detection unit 20 from the sensor control unit 32 and performs processing on the detection results of the detection unit 20. For example, the sensor processing unit 33 performs noise removal on the detection results of the detection unit 20.

For example, the sensor processing unit 33 applies a median filter to perform the noise removal on the detection results of the detection unit 20. The sensor processing unit 33 may perform processing other than the noise removal on the detection results of the detection unit 20.

Here, a detecting operation performed by the detection unit 20 will be described.

For example, the mobile body 100 shown in FIG. 2 is moving in the traveling direction FD on the transport route TR to transport the sixth transported object T6 placed in the sixth designated region R6.

In this case, the detection unit 20 detects the transported object placed in the designated region near the mobile body 100. For example, as shown in FIG. 2, the detection unit 20 has a semicircular detection range RD that is convex in the traveling direction FD. The detection range RD does not have to be semicircular.

For example, the detection range RD is a region that spreads in a predetermined direction from the detection unit 20 and has a predetermined area. The detection unit 20 detects a transported object present in the detection range RD.

In the example shown in FIG. 2, the first transported object T1 is present in the detection range RD. For that reason, the detection unit 20 shown in FIG. 2 detects the first transported object T1 placed in the first designated region R1.

The detection unit 20 may detect a transported object when at least part of the transported object is present in the detection range RD.

After the first transported object T1 is detected, the mobile body 100 shown in FIG. 2 moves in the traveling direction FD and detects the third transported object T3 placed in the third designated region R3.

That is, the mobile body 100 detects the first transported object T1 and the third transported object T3 before it arrives at the sixth designated region R6 in which the scheduled sixth transported object T6 is placed.

The determination unit 34 acquires the detection results of the detection unit 20 from the sensor processing unit 33. The information acquired by the determination unit 34 from the sensor processing unit 33 is information that has been subjected to processing such as the noise removal by the sensor processing unit 33.

In addition, the determination unit 34 acquires information (designated region information) such as coordinates of the designated region in which the transported object is disposed. The determination unit 34 may acquire the designated region information from a memory unit or the like included in the control unit 30, or may acquire the designated region information from outside the control unit 30.

The determination unit 34 determines the presence or absence of a transported object in the designated region by using the detection results of the detection unit 20. The determination unit 34 converts, for example, the detection results of the detection unit 20 acquired from the sensor processing unit 33 into information on coordinates similar to the designated region information.

The determination unit 34 determines the presence or absence of a transported object in the designated region by using the detection results of the detection unit 20 converted into the coordinates of the designated region information.

For example, the detection unit 20 detects the transported object as a point cloud. The determination unit 34 converts the detection results of the detection unit 20 into information in the sensor (detection unit 20) coordinate system based on a distance of the point detected by the detection unit 20 and an angular resolution of the detection unit 20.

The determination unit 34 converts the detection results of the detection unit 20, which have been converted into the information in the sensor coordinate system, from the information in the sensor coordinate system to information in a coordinate system of the designated region using coordinate conversion values of the coordinate system of the designated region.

The determination unit 34 may convert the detection results of the detection unit 20 into the coordinates of the designated region information using other methods. The determination unit 34 may acquire the self-position of the mobile body 100 from the movement control unit 31 and convert the detection results of the detection unit 20 into the coordinates of the designated region using the self-position of the mobile body 100.

The determination unit 34 determines the presence or absence of a transported object in the designated region by using the detection results of the detection unit 20 converted into the coordinates of the designated region information and the coordinates of the designated region.

For example, the determination unit 34 determines that a transported object is present in the designated region when at least a predetermined number of pieces of point data in the detection results of the detection unit 20 are present at the coordinates of the designated region. In addition, the determination unit 34 determines that a transported object is not present in the designated region when the number of pieces of point data present at the coordinates of the designated region is less than a predetermined number.

In this case, the determination unit 34 may perform matching of the point cloud acquired from the sensor processing unit 33 with an expected shape of the transported object, and determine that a transported object is present in the designated region when the matching result has a score of a predetermined value or more.

Even if at least the predetermined number of pieces of point data are present at the coordinates of the designated region, when the score of the matching result is less than the predetermined value, the determination unit 34 may determine that a transported object is not present in the designated region. The determination unit 34 may determine the presence or absence of a transported object in the designated region using other methods.

The movement processing unit 35 will be described later.

The transported object storage unit 200 is provided outside the mobile body 100, and is provided in, for example, a computer equipped with a processor such as a CPU, a memory, a recording storage medium such as a hard disk, a communication device, an input and output device, and the like. The transported object storage unit 200 is, for example, a recording storage medium of a computer.

The transported object storage unit 200 may be provided in a server computer disposed in a logistics warehouse or a data center, or the like, or may be provided in a cloud server, or the like. The transported object storage unit 200 is connected to the mobile body 100 to be capable of communicating with it via wired or wireless communication.

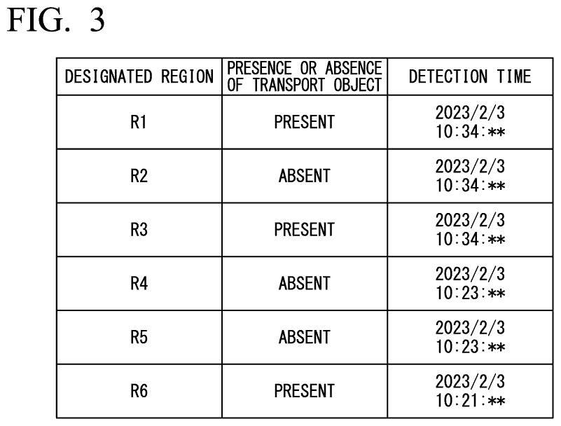

The transported object storage unit 200 has transported object information 40. FIG. 3 is a diagram showing an example of the transported object information 40.

As shown in FIG. 3, the transported object information 40 is a table in which a designated region, the presence or absence of a transported object in the designated region, and a detection time of the transported object in the designated region are associated with each other. The transported object information 40 may include other information.

After the presence or absence of a transported object in the designated region is determined, the determination unit 34 updates the transported object information 40. For example, when the presence or absence of a transported object determined by using the detection results of the detection unit 20 differs from the presence or absence of a transported object included in the transported object information 40, the determination unit 34 updates information of the transported object information 40 to information of determination results determined by using the detection results of the detection unit 20.

Even if the presence or absence of a transported object determined by using the detection results of the detection unit 20 is the same as the presence or absence of a transported object included in the transported object information 40, when a detection time at which the detection unit 20 detected the transported object differs from the detection time included in the transported object information 40, the determination unit 34 may update the detection time included in the transported object information 40 to the detection time of the detection unit 20.

The movement processing unit 35 acquires the transported object information 40 and decides the moving operation of the mobile body 100 based on the transported object information 40. For example, the movement processing unit 35 decides a scheduled transported object based on the transported object information 40 and outputs an instruction to the movement control unit 31 to transport the decided scheduled transported object.

For example, the movement processing unit 35 outputs, to the movement control unit 31, the coordinates of the designated region in which the scheduled transported object is disposed, and a moving route (transport route) to the designated region in which the scheduled transported object is disposed. The movement processing unit 35 may output information other than the coordinates and the moving route to the movement control unit 31.

For example, the movement processing unit 35 decides priorities of transported objects to be transported based on the transported object information 40, and determines the scheduled transported object based on the decided priorities.

For example, the movement processing unit 35 decides a transported object with the oldest detection time included in the transported object information 40 as the next scheduled transported object.

The movement processing unit 35 may decide the scheduled transported object based on a weight or a shape of the transported object, or a position of the designated region. For example, the movement processing unit 35 may decide a transported object in a designated region close to the current position of the mobile body 100 as the next scheduled transported object, or may exclude a transported object in a designated region far from the current position of the mobile body 100 from candidates for the scheduled transported object.

After the scheduled transported object is decided, the movement processing unit 35 may update the transported object information 40. For example, the movement processing unit 35 may add information indicating that the transported object is scheduled for transport to the transported object information 40.

The transport system 1 preferably includes a plurality of mobile bodies 100. The plurality of mobile bodies 100 are connected to the transported object storage unit 200 via wired or wireless communication, and move independently from each other to transport the transported objects.

For example, when a predetermined mobile body 100 among the plurality of mobile bodies 100 is designated as a first mobile body and a mobile body 100 different from the first mobile body is designated as a second mobile body, the first mobile body and the second mobile body transport different transported objects from each other, thereby efficiently transporting the transported objects.

For example, the movement processing unit 35 of the first mobile body selects the first transported object T1 as the scheduled transported object. The movement processing unit 35 of the first mobile body updates the transported object information 40, and adds information indicating that the first transported object T1 is the scheduled transported object of the first mobile body to the transported object information 40.

The movement processing unit 35 of the second mobile body decides the scheduled transported object of the second mobile body from the transported objects excluding the first transported object T1 scheduled to be transported by the first mobile body. By doing so, it is possible to prevent the plurality of mobile bodies 100 from deciding the same transported object as their scheduled transported objects.

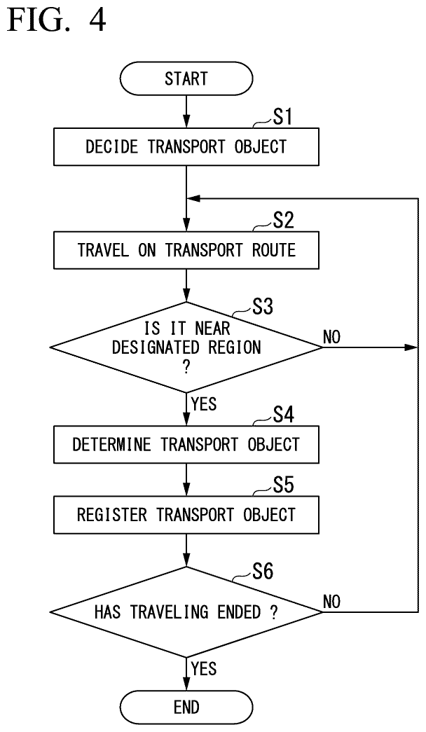

Next, a method for transporting a transported object performed by the transport system 1 will be described. FIG. 4 is a flowchart showing the method for transporting a transported object performed by the transport system 1.

### (Step S1)

First, the transport system 1 performs step S1 (a transported object decision process). In step S1, the movement processing unit 35 decides the scheduled transported object. For example, the movement processing unit 35 decides the sixth transported object T6, which has the oldest detection time, as the scheduled transported object based on the transported object information 40 shown in FIG. 3.

In this case, the movement processing unit 35 may update the transported object information 40 and add information indicating that the scheduled transported object is the sixth transported object T6 to the transported object information 40.

In the following description, a method for transporting a scheduled transported object when the transported object decided in step S1 is the sixth object T6 will be described.

### (Step S2)

Next, the transport system 1 performs step S2 (a movement process). In step S2, the movement processing unit 35 outputs an instruction to transport the sixth object T6 to the movement control unit 31. For example, the movement processing unit 35 outputs a transport route along which the mobile body 100 moves to the sixth designated region R6 to the movement control unit 31.

The movement control unit 31 controls the moving mechanism 10 based on the transport route acquired from the movement processing unit 35. The mobile body 100 moves along the transport route TR shown in FIG. 2 using the moving mechanism 10, and moves in the traveling direction FD toward the sixth object T6.

The movement control unit 31 may acquire, from the movement processing unit 35, a transport route from the current position of the mobile body 100 to the sixth designated region R6, and a transport route from the sixth designated region R6 to a destination to which the sixth transported object T6 is transported.

### (Step S3)

Next, the transport system 1 performs step S3 (a self-position determination process). In step S3, the transport system 1 determines whether or not the mobile body 100 is moving near the designated region.

Here, the movement control unit 31 performs self-position estimation from map information about a surrounding environment produced in advance and measurement results of the sensor. In addition, the movement control unit 31 compares the map information with the measurement results of the sensor, and determines that the measurement results that are different from the map information are obstacles. For that reason, the movement control unit 31 controls the moving mechanism 10 so that the mobile body 100 avoids the obstacles.

The movement control unit 31 may perform the self-position estimation by using the detection results of the detection unit 20, or may perform the self-position estimation by using detection results of other sensors.

The transport system 1 determines whether or not the mobile body 100 is moving near the designated region by using the map information and the self-position estimation result.

When the transport system 1 determines that the mobile body 100 is not moving near the designated region, it returns to step S2, and continues the movement of the mobile body 100.

When the transport system 1 determines that the mobile body 100 is moving near the designated region, it proceeds to step S4.

### (Step S4)

When it is determined in step S3 that the mobile body 100 is moving near the designated region, the transport system 1 performs step S4 (a transported object determination process). In step S4, the transport system 1 determines whether or not a transported object has been disposed in the designated region near the mobile body 100.

The mobile body 100 moving toward the sixth designated region R6 travels near the first designated region R1, for example, as shown in FIG. 2.

In step S4, the sensor control unit 32 acquires the detection results of the detection unit 20 and outputs the detection results of the detection unit 20 to the sensor processing unit 33.

In this case, the sensor control unit 32 may output an instruction to start surrounding environment measurements to the detection unit 20. In that case, the detection unit 20 starts the surrounding environment measurements based on the instruction acquired from the sensor control unit 32, and outputs the detection results to the sensor control unit 32.

The sensor processing unit 33 performs processing such as the noise removal on the detection results of the detection unit 20 acquired from the sensor control unit 32, and outputs the processed detection results of the detection unit 20 to the determination unit 34.

The determination unit 34 determines whether or not a transported object has been disposed in the designated region near the mobile body 100 by using the processed detection results of the detection unit 20 acquired from the sensor processing unit 33. In the example shown in FIG. 2, the determination unit 34 determines whether or not the first transported object T1 has been disposed in the first designated region R1.

In this case, the determination unit 34 may determine the presence or absence of a transported object based on the information acquired from the sensor processing unit 33 and the self-position information of the mobile body 100 acquired from the movement control unit 31.

### (Step S5)

Next, the transport system 1 performs step S5 (a transported object registration process). In step S5, the determination unit 34 updates the transported object information 40 by using the determination results determined in step S4.

In the present embodiment, the transported object information 40 is stored in the transported object storage unit 200 provided outside the mobile body 100.

If it is determined in step S4 that the first transported object T1 has been disposed in the first designated region R1, the determination unit 34 communicates with the transported object storage unit 200 and updates the presence or absence of a transported object in the designated region “R1” in the transported object information 40 shown in FIG. 3 to “present.”

In addition, the determination unit 34 updates the detection time at which the first transported object T1 in the first designated region R1 is detected in the transported object information 40. Here, the detection time of the transported object included in the transported object information 40 may be the time at which the detection unit 20 detects the corresponding transported object, or the time at which the determination unit 34 determines the presence or absence of a transported object.

Also, the determination unit 34 may update the transported object information 40 only when the information included in the transported object information 40 and the determination results of the determination unit 34 differ from each other.

For example, by updating the transported object information 40 only when the information regarding the presence or absence of a transported object included in the transported object information 40 and the determination results of the determination unit 34 differ from each other, it can be seen that the transported object has been placed in a predetermined designated region for a long time.

### (Step S6)

Next, the transport system 1 performs step S6 (travel end determination). In step S6, the transport system 1 determines whether to end the travel of the mobile body 100 or not.

In the case of the mobile body 100 shown in FIG. 2, the mobile body 100 is in a state in which it is traveling near the first designated region R1, and has not yet completed holding and transporting the sixth transported object T6. In this case, the transport system 1 determines that the travel of the mobile body 100 is not to be ended, and returns to step S2 and continues the travel of the mobile body 100.

The transport system 1 may make the determination in step S6 by using the self-position estimation result, or may make the determination in step S6 by using detection results of a sensor that can detect a transport status of a transported object, or the like.

If the scheduled transported object is the sixth transported object T6, the transport system 1 repeatedly performs the processes from step S2 to step S6 until the transport of the sixth transported object T6 is completed.

For example, when the mobile body 100 moves from the vicinity of the first designated region R1 in the traveling direction FD and travels near the second designated region R2, it is determined whether or not a transported object (the second transported object) has been disposed in the second designated region R2 by using the detection results of the detection unit 20, and updates the transported object information 40 by using the determination results.

In the example shown in FIG. 2, since no transported object has been disposed in the second designated region R2, the determination unit 34 updates the presence or absence of a transported object in the second designated region R2 in the transported object information 40 to “absent,” and updates the detection time.

Similarly, when the mobile body 100 moves from the vicinity of the second designated region R2 in the traveling direction FD and travels near the third designated region R3, it is determined whether or not a third transported object T3 has been disposed in the third designated region R3 by using the detection results of the detection unit 20, and updates the transported object information 40 by using the determination results.

In the example shown in FIG. 2, since the third transported object T3 has been disposed in the third designated region R3, the determination unit 34 updates the presence or absence of a transported object in the third designated region R3 in the transported object information 40 to “present,” and updates the detection time.

The transport system 1 similarly determines the presence or absence of a transported object in the fourth designated region R4 and the fifth designated region R5 by using the detection results of the detection unit 20, and updates the transported object information 40 by using the determination results.

The transport system 1 may also similarly determine the presence or absence of the sixth transported object T6, which is a scheduled transported object, by using the detections result of the detection unit 20, and update the transported object information 40 by using the determination results.

For example, if the sixth transported object T6 is moved from the sixth designated region R6 to another location by an operator, there is a possibility that the sixth transported object T6 is not disposed in the sixth designated region R6. Also, when the transport system 1 includes a plurality of mobile bodies 100, there is a possibility that the sixth transported object T6 has already been transported by another mobile body 100.

In this case, the mobile body 100 determines that the scheduled sixth transported object T6 is not disposed in the sixth designated region R6 by using the detection results of the detection unit 20.

When it is determined that the scheduled sixth transported object T6 is not disposed in the sixth designated region R6, the transport system 1 updates the transported object information 40 and again determines the scheduled transported object based on the transported object information 40. That is, the transport system 1 performs the transported object decision process of step S1.

Even if the scheduled transported object is not disposed in the designated region, by again deciding the scheduled transported object, it is possible to quickly move to the next transport operation.

When the scheduled sixth transported object T6 is disposed in the sixth designated region R6, the transport system 1 performs the operations of steps S4 and S5 on the scheduled sixth transported object T6, then holds and transports the sixth transported object T6, and transports the sixth transported object T6 to the transport destination.

The transport system 1 completes the transport of the scheduled sixth transported object T6, determines in step S6 that the travel of the mobile body 100 has ended, and ends the transport of the transported object performed by the mobile body 100.

When a plurality of transported objects are transported in succession, the transport system 1 may return to step S1 to determine the next scheduled transported object, and perform the operations from step S2 onward. For example, the transport system 1 repeatedly transports the transported objects, the surrounding environment measurements performed by the detection unit 20, and determination of the presence or absence of a transported object performed by the determination unit 34 until a preset operation end time is reached.

According to the transport system 1 of the present embodiment, the mobile body 100 is a mobile body that transports the transported objects disposed in the plurality of designated regions, which includes the moving mechanism 10 that can move the mobile body 100 along the transport route TR of the transported objects, the detection unit 20 that can detect the surroundings information, and the determination unit 34 that can acquire the detection results of the detection unit 20.

When the mobile body 100 is moving near a designated region on the transport route TR, the determination unit 34 determines the presence or absence of a transported object in the designated region by using the detection results of the detection unit 20.

As a result, it is possible to provide the mobile body 100 that can determine the presence or absence of a transported object, the transport system 1, the control device (for example, the control unit 30) that controls the mobile body 100, the method for transporting a transported object performed by the mobile body 100, and the program that controls the mobile body 100.

The presence or absence of a transported object in the designated region is determined by using the results detected by the detection unit 20 of the mobile body 100 that transports the transported object, and thus there is no need to install a detection device, such as a camera for detecting the transported object of the designated region, near the designated region.

For that reason, in the case of changing a layout of the designated regions in which the transported objects are disposed, there is no need to move an installation position of the detection device or adjust a detection range thereof, and thus the layout of the designated regions can be easily changed.

In the above embodiments, the control unit 30 that controls the mobile body 100 is provided in the mobile body 100, but it may be provided outside the mobile body 100. For example, a part or all of the configuration of the control unit that controls the mobile body may be provided in a computer or the like having the transported object storage unit 200, and may communicate with the mobile body.

In the above embodiments, the transported object storage unit 200 that has the transported object information 40 is provided outside the mobile body 100, but it may be provided in the control unit of the mobile body. For example, each of the plurality of mobile bodies may have the transported object storage unit, and the transported object information held by each of the plurality of mobile bodies may be synchronized with each other.

According to at least one of the embodiments described above, the presence or absence of a transported object in a designated region can be determined by using the results detected by the detection unit 20 included in the mobile body 100.

Although several embodiments of the present invention have been described, these embodiments are presented as examples and are not intended as limiting the scope of the invention. These embodiments can be embodied in various other forms, and various omissions, substitutions, and modifications can be made without departing from the gist of the invention. These embodiments and their modifications are included in the scope of the invention and its equivalents as described in the claims, as well as the scope and gist of the invention.

What is claimed is:

1. A mobile body to transport objects disposed in a plurality of designated regions, comprising:
a moving mechanism configured to move the mobile body along a transport route of the transported objects;
a detection unit configured to detect surroundings information; and
a determination unit configured to acquire detection results of the detection unit,
wherein the determination unit determines presence or absence of the transported objects in the designated regions by using the detection results of the detection unit when the mobile body is moving near the designated regions on the transport route.

2. The mobile body according to claim 1,
wherein the determination unit updates transported object information including the presence or absence of the transported objects in the designated regions by using the determination results of the determination unit.

3. The mobile body according to claim 2,
wherein the determination unit updates the transported object information when the determination results differ from information included in the transported object information.

4. The mobile body according to claim 2, further comprising:
a movement processing unit configured to acquire the transported object information and decide the transported object scheduled for transport by using the transported object information.

5. The mobile body according to claim 4,
wherein the movement processing unit updates the transported object information by using the transported object scheduled for transport when transport of the transported object scheduled for transport starts.

6. The mobile body according to claim 4,
wherein, when the transported object scheduled for transport is not disposed in the designated region,
the determination unit updates the transported object information, and
the movement processing unit again decides the transported object scheduled for transport by using the transported object information.

7. A transport system comprising:
a mobile body that includes a detection unit configured to detect surroundings information and transport transported objects disposed in a plurality of designated regions along a transport route;
a control device configured to control the mobile body; and
a transported object storage unit that is provided outside the mobile body and includes transported object information including presence or absence of the transported objects in the designated regions,
wherein the control device determines the presence or absence of the transported objects in the designated regions by using detection results of the detection unit when the mobile body is moving near the designated regions on the transport route, and
updates the transported object information by using the determination results.

8. The transport system according to claim 7,
wherein the control device decides the transported object scheduled for transport by using the transported object information.

9. The transport system according to claim 7, further comprising a plurality of the mobile bodies.

10. A control device configured to control a mobile body that includes a detection unit configured to detect surroundings information and transport transported objects disposed in a plurality of designated regions along a transport route,
wherein, when the mobile body is moving near the designated region on the transport route, the control device determines presence or absence of the transported objects in the designated regions by using detection results of the detection unit.

11. The control device according to claim 10,
wherein the control device updates the transported object information including presence or absence of the transported objects by using the determination results obtained by determining the presence or absence of the transported objects in the designated regions.

12. The control device according to claim 11,
wherein the control device decides the transported objects scheduled for transport by using the transported object information.

13. A method for transporting a transported object performed by a mobile body that includes a detection unit configured to detect surroundings information and transport transported objects disposed in a plurality of designated regions along a transport route, the method comprising:
determining presence or absence of the transported objects in the designated regions by using detection results of the detection unit when the mobile body is moving near the designated regions on the transport route; and
updating transported object information including the presence or absence of the transported objects by using the determination results of the transported object determination process.

14. The method for transporting a transported object according to claim 13, further comprising:
deciding the transported object scheduled for transport by using the transported object information.

15. A non-transitory computer readable storage medium that stores a program for causing a processor to execute a method of controlling a mobile body that includes a detection unit configured to detect surroundings information and transport transported objects disposed in a plurality of designated regions along a transport route, the method comprising:
determining presence or absence of the transported objects in the designated regions by using detection results of the detection unit when the mobile body is moving near the designated regions on the transport route; and
updating transported object information including the presence or absence of the transported objects by using the determination results.

16. The non-transitory computer readable storage medium according to claim 15, the method further comprising:
determining a transported object scheduled for transport by using the transported object information.
